(19) United States
(12) Patent Application Publication
(10) Pub. No.: US 2014/0272229 A1
(43) Pub. Date: Sep. 18, 2014

(54) POLYETHYLENE FOAM AND MULTILAYERED STRUCTURE INCLUDING THE SAME

(71) Applicant: Raven Industries, Inc., Sioux Falls, SD (US)

(72) Inventor: Peixiang Xing, Sioux Falls, SD (US)

(73) Assignee: Raven Industries, Inc., Sioux Falls, SD (US)

(21) Appl. No.: 14/185,748

(22) Filed: Feb. 20, 2014

Related U.S. Application Data
(60) Provisional application No. 61/780,283, filed on Mar. 13, 2013.

(51) Int. Cl. C08J 9/12; B32B 5/18; B32B 5/02; B32B 27/20; B32B 27/06

(52) U.S. Cl. CPC C08J 9/12; B32B 27/205; B32B 27/065; B32B 5/028; B32B 5/18
USPC 428/36.5; 428/305.5; 428/220; 442/1; 521/134; 156/244.11

(57) ABSTRACT

The present invention relates to polyethylene foam and materials including the same. In various embodiments, the present invention provides a foam including a solid composition including polyethylene, and a gaseous composition including a blowing agent. Various embodiments provide a multilayered structure including the foam, and methods of making and using the foam and multilayered structure. In various embodiments, the multilayered structure can be a geomembrane.

### CROSS-REFERENCE TO RELATED APPLICATION

This application claims the benefit of priority to U.S. Provisional Patent Application Ser. No. 61/780,283, filed Mar. 13, 2013, the disclosure of which is incorporated herein in its entirety by reference.

### BACKGROUND OF THE INVENTION

Geomembranes are low permeability synthetic membrane liners or barriers that can be used with geotechnical engineering materials so as to control fluid or gas migration. A floating cover is one major application of geomembranes, in which the membrane has a sufficiently low density to enable it to float on water. To make floating geomembranes using polyethylene, which generally has a density near to that of water and commonly produces foam with inadequate mechanical properties, generally materials such as polystyrene foam are attached to polyethylene sheeting to provide lower density and to avoid the use of lower-strength polyethylene foams. However, the fabrication and installation of polystyrene foam-polyethylene composite materials can be expensive and time-consuming.

Solid foams are an important class of lightweight cellular engineering materials. Their low density makes them excellent materials for thermal insulation and high-buoyancy flotation materials, and their lightness and compressibility make them ideal as packing materials and stuffings. Liner low density polyethylene (LLDPE) is a substantially linear polyethylene with significant numbers of short branches. LLDPE generally doesn't have sufficient elongation melt strength needed to support fine and well-dispersed cellular structures, and therefore cannot economically be made into useful foams.

### SUMMARY OF THE INVENTION

In various embodiments, the present invention provides a foam. The foam includes a solid composition. The solid composition includes a blend of low density polyethylene (LDPE) and a linear polyolefin. The solid composition also includes a gaseous composition. The gaseous composition includes a blowing agent. In some embodiments, the linear polyolefin includes at least one of HDPE, MDPE, LLDPE, VLDPE, ULDPE, and polyolefin plastomer. In some embodiments, the linear polyolefin includes LLDPE.

In various embodiments, the present invention provides a foam. The foam includes a solid composition. The solid composition includes a blend of low density polyethylene (LDPE) and LLDPE. The foam also includes a gaseous composition. The gaseous composition includes a blowing agent.

In various embodiments, the present invention provides a multilayered structure. The multilayered structure includes at least one first layer including polyethylene. The multilayered structure also includes at least one second layer. The at least one second layer includes a foam that includes a solid composition including a blend of LDPE and a linear polyolefin, and a gaseous composition including a blowing agent. In some embodiments, the at least one first layer is in contact with the at least one second layer.

In various embodiments, the present invention provides a multilayered structure. The multilayered structure includes a), at least one first layer including polyethylene. The multilayered structure includes b), at least one second layer including a foam that includes a solid composition including a blend of LDPE and a linear polyolefin, and a gaseous composition including a blowing agent. The multilayered structure also includes c) at least one first layer including polyethylene. Layer a) is in contact with layer b), and layer b) is in contact with layer c).

In various embodiments, the present invention provides a multilayered structure. The multilayered structure includes a), at least one first layer including polyethylene. The multilayered structure includes b), at least one second layer including a blend of LDPE and a linear polyolefin, and a gaseous composition including a blowing agent. The multilayered structure includes c), at least one first layer including polyethylene. The multilayered structure includes d), at least one reinforcing layer including scrim and optionally including polyethylene. The multilayered structure includes e), at least one first layer including polyethylene. The multilayered structure includes f), at least one second layer including a blend of LDPE and a linear polyolefin, and a gaseous composition including a blowing agent. The multilayered structure includes g), at least one first layer including polyethylene. Layer a) is in contact with layer b), layer b) is in contact with layer c), layer c) is in contact with layer d), layer d) is in contact with layer e), layer e) is in contact with layer f), and layer f) is in contact with layer g).

In various embodiments, the present invention provides a multilayered structure. The multilayered structure includes a), at least one first layer including about 95 wt % to about 100 wt % LLDPE. The multilayered structure includes b), at least one second layer including a foam. The foam includes a solid composition including a blend of LDPE and a linear polyolefin, the composition including about 20 wt % to about 80 wt % LDPE and about 20 wt % to about 80 wt % of the linear polyolefin. The foam also includes a gaseous composition including a blowing agent. The multilayered structure also includes c), at least one first layer including about 95 wt % to about 100 wt % LLDPE. The multilayered structure also includes d), at least one reinforcing layer including scrim and optionally including polyethylene. The multilayered structure also includes e), at least one first layer including about 95 wt % to about 100 wt % LLDPE. The multilayered structure also includes f), at least one second layer including a foam. The foam includes a solid composition including a blend of LDPE and a linear polyolefin, the composition including about 20 wt % to about 80 wt % LDPE and about 20 wt % to about 80 wt % of the linear polyolefin. The foam also includes a gaseous composition including a blowing agent. The multilayered structure also includes g), at least one first layer including about 95 wt % to about 100 wt % LLDPE. Layer a) is in contact with layer b), layer b) is in contact with layer c), layer c) is in contact with layer d), layer d) is in contact with layer e), layer e) is in contact with layer f), and layer f) is in contact with layer g). The multilayered structure has a total thickness of about 30 mils to about 80 mils. The multilayered structure has an overall density of about 0.7 g/cm³ to about 0.9 g/cm³.

In various embodiments, the present invention provides a multilayered structure. The multilayered structure includes a), at least one first layer including polyethylene. The multilayered structure includes b), at least one second layer including a foam. The foam includes a solid composition including LDPE, LLDPE, MDPE, HDPE, VLDPE, ULDPE, polyolefin plastomer, or any combination thereof. The foam also includes a gaseous composition including a blowing agent. The multilayered structure includes c), at least one first layer including polyethylene. The multilayered structure also includes d), at least one reinforcing layer including scrim and optionally including polyethylene. Layer a) is in contact with layer b), layer b) is in contact with layer c), and layer d) is in contact with the at least one first layer a) or c).

In various embodiments, the present invention provides a method of making a multilayered structure. The method includes extruding a foam layer. The foam layer includes a blend of LDPE and a linear polyolefin. The foam layer also includes a gaseous composition including a blowing agent. The method includes extruding a first layer including polyethylene. The method includes assembling a multilayered structure. The multilayered structure also includes b) at least one of a second layer including the foam layer. The multilayered structure includes c) at least one of the first layer including polyethylene. Layer b) is in contact with layer c). In some embodiments, the method includes adding layer d), at least one reinforcing layer including scrim and optionally including polyethylene, wherein layer d) is in contact with layer c).

Certain embodiments of the present invention have advantages over other foams, multilayered structures, geomembranes, methods of making the same, and methods of using the same, at least some of which are unexpected. In various embodiments, the foam or multilayered structure of the present invention can have superior physical and mechanical properties as compared to other foams and multilayered materials including the same. In various embodiments, the foams and multilayered structures of the present invention can be less dense or stronger than other foams or polyethylene-containing multilayered structures made with similar time or cost. For example, various embodiments of the foam or the multilayered structure can have a greater tear strength than foams made from LDPE alone, or than multilayered structures including the same. Various embodiments of the multilayered structure that include LLDPE skin layers in contact with the foam can have greater strength or toughness than corresponding multilayered structures having skins made from other materials such as LDPE.

In various embodiments, the foam and multilayered structures including the same can be more efficiently and cost-effectively fabricated than other polyethylene foams and multilayered materials including high-buoyancy foams. In various examples, fabrication of the foam or multilayered structure can conveniently be performed using less non-polyethylene materials than other similarly low-density polyethylene-containing foams or multilayered structures having similar or less strength. For example, in various embodiments a high strength and high buoyancy foam or multilayered structure including the same can be formed using less polystyrene than other foams or multilayered structures including the same that have similar strength or buoyancy. In various examples, the foam or multilayered structure including the same can provide a geomembrane at reduced cost or improved performance compared to geomembranes made of different materials, such as geomembranes including polystyrene and polyethylene.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document

FIG. 1 illustrates a multilayered structure and method of making the same, in accordance with various embodiments.

FIG. 2 illustrates a multilayered structure and method of making the same, in accordance with various embodiments.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “solvent” as used herein refers to a liquid that can dissolve a solid, liquid, or gas. Nonlimiting examples of solvents are silicones, organic compounds, water, alcohols, ionic liquids, and supercritical fluids.

The term “air” as used herein refers to a mixture of gases with a composition approximately identical to the native composition of gases taken from the atmosphere, generally at ground level. In some examples, air is taken from the ambient surroundings. Air has a composition that includes approximately 78% nitrogen, 21% oxygen, 1% argon, and 0.04% carbon dioxide, as well as small amounts of other gases.

The term “mil” as used herein refers to a thousandth of an inch, such that 1 mil=0.001 inch.

The term “polymer” as used herein can include a copolymer, unless otherwise indicated. In some embodiments, a polymer can include a copolymer. In other embodiments a polymer does not include a copolymer.

As used herein, the term “polyolefin” can include a polymer or copolymer.

### Foam.

In various embodiments, the present invention provides a foam. The foam can have any suitable foam structure having pockets of gas in a solid material. The cellular structure of the foam can have an open, partially-open, or closed structure. The foam includes a solid composition that forms the solid features of the foam. The solid composition can include polyethylene, such as a linear polyethylene, such as LDPE, LLDPE, MDPE, HDPE, VLDPE, ULDPE, polyolefin plastomer, or any combination thereof. The solid composition can include a blend of LDPE and a linear polyolefin. In some embodiments, the solid composition includes a blend of LDPE and at least one of HDPE, MDPE, LLDPE, VLDPE, ULDPE, and polyolefin plastomer. In some embodiments, the solid composition includes a blend of LDPE and LLDPE. The foam also includes a gaseous composition that forms the gaseous cellular features of the foam. The gaseous composition includes a blowing agent.

The foam can be produced in any suitable manner. In some examples, the foam is an extruded sheet. The foam can have any suitable thickness. In some examples, the foam can have a thickness of about 1 mils to about 3000 mils, 1 mils to 300 mils, 5 mils to about 500 mils, about 10 mils to about 250 mils, about 20 mils to about 100 mils, or about 30 mils to about 80 mils, or about 1 mil, 2 mils, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, or about 300 mils. The foam can have any suitable density. In various embodiments, the foam has a density that allows the foam or a multilayered structure including the same to have buoyancy in water or a solution including water. In some examples, the foam can have a density of a density of about 0.3 to about 1.2 g/cm³, about 0.4 to about 1.1 g/cm³, or about 0.5 to about 0.9 g/cm³, or about 0.7 g/cm³ to about 0.8 g/cm³. In some examples, the foam has a density of about 0.3 g/cm³ or less, about 0.35 g/cm³, 0.4, 0.45, 0.5, 0.55, 0.6, 0.65, 7, 0.75, 0.8, 0.85, 0.9, 0.95, 1.0, 1.05, 1.1, 1.15, or about 1.2 g/cm³ or more. In various examples, the foam can have a cell size of about 0.1 to about 100 mil, 0.5 to 50 mil, 0.5 to 20 mil, or about 1 to 8 mil.

In some examples, the foam can have a high puncture or tear resistance. In various embodiments, the foam can have a greater strength than other foams, such as foams having a solid component of LDPE that doesn't include a linear polyolefin; or having a solid component of LDPE that doesn't include at least one of HDPE, MDPE, LLDPE, VLDPE, ULDPE, and polyolefin plastomer; or having a solid component of LDPE that doesn't include LLDPE. The foam can have any suitable strength, consistent with the compositions described herein. For example, the foam can have a tensile strength of about 0.001-1000 lbf/in, 50-500 lbf/in, 100-300 lbf/in, 130-250 lbf/in, 150-200 lbf/in, or about 160-180 lbf/in. In some embodiments, the foam can have a tear resistance of about 1-1000 lbf/in, 50-500 lbf, 100-300 lbf, 130-250 lbf, 150-200 lbf, or about 170-190 lbf. In some examples, the foam can have puncture resistance of about 1-1000 lbf/in, 10-500 lbf, 30-250 lbf, 80-180 lbf, or about 110-130 lbf.

### Solid Composition.

The foam includes a solid composition that forms the solid features of the foam. The solid composition can include polyethylene, such as a linear polyethylene, such as LDPE, LLDPE, MDPE, HDPE, VLDPE, ULDPE, polyolefin plastomer, or any combination thereof. The solid composition can include a blend of LDPE and a linear polyolefin. The linear polyolefin can be any suitable linear polyolefin. The linear polyolefin can be a polymer or a copolymer. In some embodiments, the solid composition includes a blend of LDPE and at least one of HDPE, MDPE, LLDPE, VLDPE, ULDPE, and polyolefin plastomer. In some embodiments, the solid composition includes a blend of LDPE and LLDPE. The blend can be any suitable blend, with any suitable degree of mixing and any suitable proportions of LDPE and the linear polyolefin. In some examples, the LDPE and a linear polyolefin are substantially homogenously mixed. In some examples, the solid composition is about 0.1 wt % to about 99.9 wt % of the linear polyolefin, 30 wt % to about 99.9 wt %, or about 20 wt % to about 80 wt % of the linear polyolefin (e.g. such as LLDPE). In some examples, the solid composition is about 0.1 wt % to about 99.9 wt % of the linear polyolefin, about 20 wt % to about 80 wt %, or about 40 wt % to about 60 wt % of the linear polyolefin.

The solid composition can include any other suitable component in the solid composition, in the blend, or in any combination thereof. In various embodiments, the solid composition can include at least one of a UV stabilizer, a UV absorber, an antioxidant, a pigment material, a filler (e.g., calcium carbonate, ground up nut shells, mica, wood powder, waste plant matter, flour), or a polyolefin. The pigment material can be any suitable pigment material, such as carbon black (to generate a black color), titanium dioxide (to generate a white color), or such as other suitable pigments to generate any suitable color such as red, green, blue, yellow, grey, tan, and the like. In some examples, the solid composition can include at least one of a nucleating agent, a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, an antioxidant, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, carbon black, a polyolefin, a linear polyolefin, a linear polyolefin copolymer, UHMWPE, HDPE, PEX, XLPE, MDPE, VLDPE, ULDPE, a polyolefin plastomer, a chemical blowing agent, a chemical blowing agent residue, and a flow control additive. In some examples, a nucleating agent is adding during formation of the foam to nucleate bubble formation and aid in the formation of the foam. The nucleating agent can be any suitable nucleating agent; in some examples, the nucleating agent is calcium carbonate.

As used herein, linear low-density polyethylene (LLDPE) can be any LLDPE as is commonly understood in the art. LLDPE has a substantially linear polymer with significant numbers of short branches, and in some examples can be made by copolymerization of ethylene with longer-chain olefins, for example, butene, hexene, or octene. LLDPE can have less long-chain branching than LDPE. LLDPE can have a narrower molecular weight distribution than LDPE, and different rheological properties. LLDPE can have a density of about 0.918 to 0.935 g/cm³, or about 0.919 to 0.925 g/cm³. As used herein, low-density polyethylene (LDPE) can be any LDPE as is commonly understood in the art. LDPE can have a high degree of short and long chain branching. In some examples, LDPE can have branching on about 0.5-5 mol % of carbon atoms, 1-3 mol %, or on about 2 mol % of carbon atoms. LDPE can have a density of about 0.910 g/cm³ to about 0.940 g/cm³. LDPE can be functionalized LDPE or unfunctionalized LDPE. Functionalized LDPE can include an ethylene-vinyl acetate copolymer.

As used herein, the terms ultra high molecular weight polyethylene (UHMWPE), high density polyethylene (HDPE), and cross-linked polyethylene (PEX/XLPE) are used as commonly understood in the art.

As used herein, medium density polyethylene (MDPE) can be any MDPE as is commonly understood in the art. For example, MDPE can have a density of about 0.926 g/cm³ to about 0.940 g/cm³. MDPE can have good shock and drop resistance properties. It can be less notch sensitive than HDPE. Stress cracking resistance can be better than that of HDPE.

As used herein, a very low density polyethylene (VLDPE) can be any VLDPE as is commonly understood in the art. For example, VLDPE can have a density of about 0.900 g/cm³ to about 0.914 g/cm³.

As used herein, an ultra low density polyethylene (ULDPE) can be any ULDPE as is commonly understood in the art. For example, ULDPE can have a density of about 0.867 g/cm³ to 0.899 g/cm³, or about 0.88 g/cm³ to about 0.899 g/cm³.

As used herein, a polyolefin plastomer (POP) can be any POP as is as is commonly understood in the art. POPs can bridge the gap between plastics and elastomers. A POP can be a polyolefin that has a density of about 0.865 g/cm³ to about 0.88 g/cm³, or about 0.865 g/cm³ to about 0.914 g/cm³.

The solid composition can have any suitable melt strength consistent with the compositions described herein. In some examples, the solid composition has a higher melt strength than other solid compositions used to form foams, such as higher than other polyethylene solid compositions used to form foams, such as higher than other solid compositions used to form foams that include LLDPE but that do not include LDPE.

### Blowing Agent.

The foam includes a gaseous composition that forms the gaseous cellular features of the foam. The gaseous composition includes a blowing agent. The blowing agent can be any suitable blowing agent. For example, the blowing agent can be at least one of a branched or linear C₁₋₅ alkane, ethane, propane, butane, n-butane, isobutane, pentane, isopentane, cyclopentane, halo(C₁₋₅)alkanes, chlorofluorocarbon, CFC-11, CFC-12, hydroflurochlorocarbons, HCFC-22, HCFC-122, HCFC-124, HFC-152a, HFC-143a, HFC-134a, HCFC-141b, HCFC-142b, air, carbon dioxide, oxygen, hydrogen, water, and nitrogen. In some embodiments, the blowing agent is physically introduced during the manufacturing process of the foam, such as by stirring, generation of bubbles from an immersed location, blending, whisking, or any combination thereof, or by injecting into an extruder during extrusion of the foam. Blowing agents can be introduced at any suitable time during the process. For example, physical blowing agents (e.g., gases) can be introduced during extrusion. For example, chemical blowing agents can be introduced prior to extrusion or during extrusion.

In some embodiments, the blowing agent is generated via a chemical reaction of chemical blowing agents. Chemical blowing agents can be one or more solid or liquid materials that are added to the solid composition that generates the foam during the foam manufacturing process. Chemical blowing agents can react during the foam manufacturing process to form bubbles that include blowing agent. Chemical blowing agents can include any suitable chemical blowing agent. In some examples, a chemical blowing agent can be azodicarbonamide, an azodicarbonamide derivative, sodium bicarbonate, an aliphatic sulfonyl semicarbazide, p-toluenesulfonylhydrazide, p-toluenesulfonylsemicarbazide, 4,4-oxybisbenzenesulfonylhydrazide, 5-phenyltetrazole, citric acid, and Ecocell™ chemical blowing agents such as Ecocell-H™.

### Multilayered Structure.

In various embodiments, the present invention provides a multilayered structure that includes the foam described herein. The multilayered structure can be any suitable structure that includes the foam including the solid composition including polyethylene described herein. The multilayered structure can be any suitable size or shape. The multilayered structure can have any suitable physical and chemical characteristics consistent with the composition of the multilayered structure as described herein. In some embodiments, the multilayered structure includes at least one layer of the foam and at least one layer of polyethylene, such as a polyethylene skin. In some embodiments, the multilayered structure includes at least one reinforcing layer including scrim and optionally including polyethylene. The multilayered structure can be formed in any suitable manner. In some examples, the multilayered structure can be formed using an extrusion technique, such as by continuous cast extrusion. In some embodiments, a multilayered structure including foam or including foam and at least one polyethylene protective skin can be formed by continuous cast extrusion, and additional layers such as scrim layers can be added using other suitable techniques such as lamination; in other embodiments, the entire multilayered structure can be formed using continuous cast extrusion.

In some embodiments, the multilayered structure includes at least one first layer including polyethylene; at least one second layer including the foam including the solid composition. The first and second layer can be contacting, or not contacting (e.g., they can be non-adjacent layers of the multilayered structure).

Each layer can be partially or fully in contact with the one or more adjacent layers. For one layer to contact the other layer, the surface of one layer can be fused to the other, such that the planar distributions of material in each layer are adjacent to the another. In some examples, contacting can include at least some mixing of the materials in one layer with the other layer. In some examples, two layers in contact with one another can include a two layers having a different material at the interface between layers due to a chemical reaction at the time of fusing or later, or due to the application of adhesive or other bonding agent between the layers, or a combination thereof. Two contacting layers having substantially all of the major side of at least one layer contacting at least part of the major side of another layer can be fully contacting one another. In another example, two layers can be fully contacting one another when substantially all of one major side of one layer is contacting substantially all of one major side of the other layer. Two layers can be partially contacting one another when a major side from one layer contacts a major side of another layer, but less than all of a major side of one layer is contacting less than all of a major side of the other layer. In embodiments that include an adhesive or bonding agent between one or more pairs of layers, the adhesive or bonding agent can be any adhesive or bonding agent used for forming multilayer structures as are commonly known to those of skill in the art.

In some embodiments, the multilayered structure includes a), at least one first layer including polyethylene; and b) at least one second layer including the foam including the solid composition including the polyethylene described herein; wherein layer a) is in contact with layer b).

In some examples, the multilayered structure can be a sandwich the foam including solid composition including the polyethylene described herein between two polyethylene protective skin layers. In various examples, in addition to the sandwich of three layers, the multilayered structure can include any suitable layer, or no additional layer. Thus, in some embodiments, the multilayered structure includes a), at least one first layer including polyethylene; b), at least one second layer including the foam including the solid composition including the polyethylene described herein; and c), at least one first layer including polyethylene; wherein layer a) is in contact with layer b), and layer b) is in contact with layer c).

In various embodiments, the multilayered structure can include at least one layer of scrim and one layer of the foam including the solid composition. In some examples, the present invention provides a multilayered structure including d), at least one reinforcing layer including scrim and optionally including polyethylene; c), at least one first layer including polyethylene; and b), at least one second layer including the foam of claim 1; wherein layer b) is in contact with layer c), and layer c) is in contact with layer d). In various embodiments, the present invention provides a foam layer sandwiched between polyethylene protective skin layers, having one or both protective skin layers laminated or otherwise attached to a scrim layer that optionally includes polyethylene. For example, in various embodiments, the present invention provides a multilayered structure, including a), at least one first layer including polyethylene; b), at least one second layer including a solid composition including polyethylene and a gaseous composition including a blowing agent; c), at least one first layer including polyethylene; d), at least one reinforcing layer including scrim and optionally including polyethylene; e), at least one first layer including polyethylene; f), at least one second layer including a solid composition including polyethylene and a gaseous composition including a blowing agent; and g), at least one first layer including polyethylene; wherein layer a) is in contact with layer b), layer b) is in contact with layer c), layer c) is in contact with layer d), layer d) is in contact with layer e), layer e) is in contact with layer f), and layer f) is in contact with layer g). In some embodiments, layer c) can be in contact with layer e) through scrim layer d). In some embodiments, the scrim layer d) can be incorporated in one or both adjacent polyethylene layers c) and e), such that polyethylene layers c) and e) are contacting one another through gaps in the scrim, and such that layers c), d), and e) can be characterized as a single layer of polyethylene combined with scrim incorporated therein.

The multilayered structure can have any suitable total thickness. The total thickness of the multilayered structure can be the same as the total thickness of all the layers that are included in the multilayered structure. In some examples, the multilayered structure has a total thickness of about 1 mils to about 3000 mils, 1 mils to 300 mils, 5 mils to about 500 mils, about 10 mils to about 250 mils, about 20 mils to about 100 mils, or about 30 mils to about 80 mils, or about 1 mil, 2 mils, 3, 4, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, or about 300 mils.

The multilayered structure can have any suitable overall density. In various embodiments, the overall density of the multilayered structure is sufficient to give the multilayered structure a high enough buoyancy in water or solutions including water such that the multilayered structure can be used effectively as a floating geomembrane. In some examples, the multilayered structure can have a density equal to or less than a corresponding multilayered structure having polystyrene foam in place of the foam including the solid composition including. In some examples, the multilayered structure has a density of about 0.3 to about 1.3 g/cm³, about 0.4 to about 1.1 g/cm³, about 0.6 to about 1.1 g/cm³, or about 0.5 to about 0.9 g/cm³, or about 0.7 g/cm³ to about 0.8 g/cm³. In some examples, the multilayered structure has a density of about 0.3 g/cm³ or less, about 0.35 g/cm³, 0.4, 0.45, 0.5, 0.55, 0.6, 0.65, 7, 0.75, 0.8, 0.85, 0.9, 0.95, 1.0, 1.05, 1.1, 1.15, 1.2, 1.25, or about 1.3 g/cm³ or more.

In various embodiments, the multilayered structure can have a high puncture or tear resistance. The multilayered structure can have a greater strength than other multilayered structures, such as greater than multilayered structure including a foam that includes a solid component including LDPE but not including a linear polyolefin. The multilayered structure can have any suitable strength, consistent with the compositions and structures described herein. For example, the multilayered structure can have a tensile strength of about 0.001-1000 lbf/in, 50-500 lbf/in, 30-100 lbf/in, 60-80 lbf/in, 100-300 lbf/in, 130-250 lbf/in, 150-200 lbf/in, or about 160-180 lbf/in. In some embodiments, the multilayered structure can have a tear resistance of about 1-1000 lbf/in, 50-500 lbf, 30-100 lbf, 60-80 lbf, 100-300 lbf, 130-250 lbf, 150-200 lbf, or about 170-190 lbf. In some examples, the multilayered structure can have puncture resistance of about 1-1000 lbf/in, 10-500 lbf, 10-100 lbf, 10-80 lbf, 30-250 lbf, 80-180 lbf, or about 110-130 lbf.

The multilayered structure can be used in any fashion consistent with its physical and chemical characteristics. The multilayered structure can be used for packaging such as food packaging or packaging for other commodities, bags, labels, building construction, landscaping, electrical fabrication, geomembrane liners, landfill covers, floating covers, or pond and pit liners. In some examples, the multilayered structure can be used as a film or lining in a construction setting, in an agricultural setting, or as a geomembrane. In some examples, construction applications can include enclosure films, vapor retarders or barriers, gas barriers, or door and window flashings. Geomembrane applications can include, for example, landfill covers and caps, geo foam protection, remediation covers, floating covers, erosion control covers, or pond and pit liners. Agricultural applications can include, for example, silage bunker covers, grain storage covers, floating covers, pond liners, sugar beet covers, or fumigation films. Energy sector applications can include reserve pit liners, frac pit liners, evaporation ponds, water holding ponds, and non-skid deck liners. In various embodiments, the present invention provides a method of using the multilayered structure consistent with the uses described herein.

### Polyethylene Layer.

In some embodiments, the multilayered structure includes at least one layer of the foam and at least one layer including polyethylene, such as a polyethylene skin or a polyethylene protective layer. In some embodiments, the foam layer contact the at least one polyethylene skin or polyethylene protective layer. The polyethylene layer can protect the surface of the foam, can help to improve the mechanical properties of the foam, such as by increasing the strength of the foam. The polyethylene layer can include any suitable polyethylene, such as UHMWPE, HDPE, PEX, XLPE, MDPE, LLDPE, LDPE, VLDPE, or any combination thereof.

In some examples, the polyethylene layer (e.g., the at least one first layer) includes LLDPE. The polyethylene layer can include any suitable amount of LLDPE, for example about 50 wt % to about 100 wt %, about 80 wt % to about 100 wt %, or about 95-100 wt % LLDPE. In some examples, the polyethylene layer includes LDPE. The polyethylene layer can include any suitable amount of LDPE, for example about 0 wt % to about 50 wt % LDPE, about 0 wt % to about 20 wt % LDPE, about 0 wt % to about 5 wt % LDPE.

The polyethylene layer can include any other suitable component. For example, the polyethylene layer can include at least one of a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, an antioxidant, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, an antioxidant, a pigment, a polyolefin, and a flow control additive.

The polyethylene layer can have any suitable thickness. For example, the polyethylene layer can have a thickness of about 0.5 mils to about 100 mils, about 1 mils to about 40 mils, or about 2 mils to about, 20 mils, or about 0.5 mils or less, or about 1, 2, 3, 4, 5, 6, 7, 8, 9, 10, 11, 12, 13, 14, 15, 16, 17, 18, 19, 20, 22, 24, 26, 28, 30, 35, 40, 45, 50, 60, 70, 80, 90, or about 100 mils or more.

The polyethylene layer can be bonded to other layers, such as a foam layer, in any suitable fashion. In some embodiments, the polyethylene layer is bonded to the foam layer using adhesive. In other embodiments, the polyethylene layer is melted to the foam layer during the extrusion process to form an adequate bond, e.g., without adhesives.

### Scrim.

In some embodiments, the multilayered structure includes at least one reinforcing layer. The reinforcing layer can be any reinforcing layer, such as woven or nonwoven fabrics, such as coated woven or nonwoven fabrics, or such as scrim. In some embodiments, the multilayered structure includes one layer of scrim. In other embodiments, the multilayered structure includes at least two or more layers of scrim. In some examples, the at least one layer of reinforcing scrim is in contact with the at least one first layer that includes polyethylene.

As used herein, a scrim can be a knitted or woven mesh of reinforcing fibers, or a scrim can be a laid scrim which includes at least two layers of unknitted unwoven yarns that can be layered such that the yarns are oriented in different directions. The scrim can be any suitable scrim, as is understood by one of skill in the art. For example, the scrim can includes fibers (e.g., yarn) that include at least one of glass, polyester, polyethylene, polypropylene, nylon, carbon, Aramid, and metal or metal alloys such as steel.

The scrim can have any suitable denier of yard therein, wherein the yard can have any suitable shape. In some examples, the scrim can be made from yards of about 100 denier to about 5000 denier, about 300 denier to about 3000 denier, or about 600 denier to about 1300 denier. In some examples, the yarn is approximately cylindrical. In some examples, the yarn is tape-like.

The scrim can be bonded or encapsulated within other layers, such as polyethylene or foam layer, in any suitable fashion. In some embodiments, multilayered structures (e.g. 3 layered structures of PE skin/foam/PE skin) are pressed on either side of the scrim with at least one contacting polyethylene layer being hot enough to mold around the scrim during the pressing so as to produce an encapsulated scrim layer in the center of the resulting structure. In some embodiments, the scrim layer is bonded to the foam layer using adhesive. In other embodiments, the scrim layer is added to a foam or polyethylene skin layer while the layer is still hot, allowing the scrim layer to be incorporated in the molten polymer prior to hardening, e.g., without the use of adhesives. In some embodiments, the scrim layer is added to other layers by lamination using a hot melted (e.g., molten or semi-molten) polyethylene layer, such that the scrim layer is held in place via bonding between the polyethylene layer and the other layers. The scrim can be incorporated into the hot melt polyethylene layer to any suitable extent during the lamination. As used herein, the reinforcing layer can include the layer of scrim and the layer of hot melt polyethylene wherein the scrim and the polyethylene are incorporated together to any suitable extent, for example, the scrim can be predominantly positioned on one side of the polyethylene, or the scrim can be fully encapsulated within the polyethylene.

### Method of Making the Multilayered Structure.

In various embodiments, the present invention provides a method of making the foam described herein including the solid composition. The method can be any suitable method. For example, the method can include combining or obtaining the polyethylene, such as an appropriate blend of a linear polyolefin and LDPE, and extruding the blend. The method can further include adding a blowing agent, for example by physically mixing the blowing agent into the polyethylene (e.g., into a blend of LDPE and a linear polyolefin) before or during the extrusion (e.g., the physical blowing agent can be introduced during extrusion by injecting directly into the extruder), or adding a chemical blowing agent before or during the extrusion. The extrusion can be any suitable extrusion. For example, the extrusion can be a continuous cast sheet extrusion. The extrusion can include any suitable other processing, such as mixing, drying, curing, heating, and the like.

In various embodiments, the present invention provides a method of making the multilayered structure described herein. The method can include, for example, extruding a foam layer including a solid composition including polyethylene, and a gaseous composition including a blowing agent, for example, cast extrusion or blown film or blown sheet extrusion. The method can also including extruding a first layer including polyethylene. The method can also include assembling a multilayered structure, the multilayered structure including a), at least one of the first layer including polyethylene, and c), at least one of a second layer including the foam layer, wherein layer b) is in contact with layer c). In some embodiments, the polyethylene protective skin layer can be extruded separately from the foam layer, such as via any suitable method, for example using cast sheet extrusion, cast film extrusion, blown sheet extrusion, and blown film extrusion. In some examples, the foam layer and the polyethylene layer can be assembled in a continuous process shortly after they are individually extruded, while in other examples the foam layer and the polyethylene layer are partially or completely extruded prior to assembly of the layers. The assembly can occur by any suitable method, and can include, for example, application of adhesives or bonding agents, application of pressure, drying, curing, heating, and the like. Adhesives or bonding agents, if present, can be applied in any suitable fashion.

In some embodiments, the method can include extruding a multilayered structure on another multilayered structure, such that the hot freshly extruded multilayered structure is welded or bonded to the other multilayered structure. In some embodiments, the method includes welding or bonding a 3-layer extruded structure having two polyethylene film layers sandwiching a foam layer onto another similar 3-layer structure, providing a laminated structure having at least 6 layers.

In some embodiments, the method can include adding to the multilayered structure layer d), at least one reinforcing layer including scrim and optionally including polyethylene; wherein layer d) is in contact with layer c). In some embodiments, the scrim can be added to a protective polyethylene skin/foam multilayered structure in a continuous process shortly after assembly of the foam/polyethylene skin multilayered structure. In other embodiments, the scrim can be added after most or all of the foam/polyethylene multilayered structure is assembled. The scrim can be added using any suitable process. For example, the scrim can be sandwiched between two polyethylene skin/foam multilayered structures, such as while at least one of the multilayered structures is still hot from extrusion to allow incorporation of the scrim and lamination of the multilayered structures together around the scrim. Sandwiching the scrim between the polyethylene sheets can occur via any suitable process, for example, lamination, extruding a solid polyethylene film layer between the two polyethylene sheets while inserting the scrim, inserting a molten polyethylene sheet that molds around the scrim, adding an adhesive that joins the polyethylene layers together around the scrim, or heating one or more of the polyethylene layers such that they soften and can be pressed around the scrim to encapsulate the same. In some embodiments, the scrim layer is added to other layers by lamination using a hot melted (e.g., molten or semi-molten) polyethylene layer, such that the scrim layer is held in place via bonding between the polyethylene layer and the other layers. The scrim can be incorporated into the hot melt polyethylene layer to any suitable extent during the lamination. As used herein, the reinforcing layer can include the layer of scrim and the layer of hot melt polyethylene wherein the scrim and the polyethylene are incorporated together to any suitable extent, for example, the scrim can be predominantly positioned on one side of the polyethylene, or the scrim can be fully encapsulated within the polyethylene.

In some embodiments, multiple extruders can be used to make several parts of a multi-layered structure simultaneously. For example, two separate dies can be used to extrude two separate multi-layered (e.g. three-layered PE skin/foam/PE skin) structures using two extruders, each of which can then be laminated together around a reinforcing scrim in any suitable way, such that the process is continuous. In various examples, any two or more steps can be performed simultaneously.

In some examples, a nucleating agent is adding during formation of the foam to nucleate bubble formation and aid in the formation of the foam. The nucleating agent can be any suitable nucleating agent; in some examples, the nucleating agent is calcium carbonate.

FIG. 1 illustrates a reinforced foamed sheet and a process of making the same. The right image in FIG. 1 shows a multilayered structure, including foamed layers e and b, the foam including a solid composition including polyethylene (e.g., a blend of LDPE and a linear polyolefin), and a gaseous composition including a blowing agent. The multilayered structure includes non-foamed polyethylene layers a, c, e, and g. The multilayered structure also includes a layer of scrim d sandwiched between layers c and e such that layers c and e contact one another through scrim layer d.

The left image in FIG. 1 illustrates a foamed 3-layer sheet formed by cast extrusion. The middle image in FIG. 1 illustrates a cast or lamination process using scrim. The melt of a second foamed 3-layer sheet formed by cast extrusion, having layers e-f-g, is cast (e.g., laminated) with scrim layer d on the foamed 3-layer sheet a-b-c, welding or bonding the e layer to the c layer with the scrim layer d therebetween. The right image in FIG. 1 illustrates the resulting multilayered structure. The scrim layer d is sandwiched between polyethylene layers c and e, and can be predominantly embedded within layer e due to 3-layer sheet e-f-g being in a melted or semi-melted state at the time of lamination onto 3-layer sheet a-b-c.

FIG. 2 illustrates a reinforced foamed sheet and a process of making the same. The right image in FIG. 2 shows a multilayered structure, including foamed layers g and b, the foam including a solid composition including polyethylene (e.g., a blend of LDPE and a linear polyolefin), and a gaseous composition including a blowing agent. The multilayered structure includes non-foamed polyethylene layers a, c, e, f, and h. The multilayered structure also includes a layer of scrim d sandwiched between layers c and f in layer e.

The left image in FIG. 2 illustrates a foamed 3-layer sheet formed by cast extrusion. The middle image in FIG. 2 illustrates a lamination process using scrim and hot freshly extruded layer e. A second foamed 3-layer sheet formed by cast extrusion, having layers f-g-h, is laminated with scrim layer d onto the foamed 3-layer sheet a-b-c using hot melt layer e, bonding the e layer to the c layer and the f layer with the scrim layer d therebetween. The right image in FIG. 2 illustrates the resulting multilayered structure. The scrim layer d is sandwiched between polyethylene layers c and f, and can be predominantly embedded within layer e due to layer e being in a melted (e.g., molten) or semi-melted state at the time of lamination between the three layer sheets.

### EXAMPLES

The present invention can be better understood by reference to the following examples which are offered by way of illustration. The present invention is not limited to the examples given herein.

### Example 1

### Multilayered Structure

Following the process illustrated in FIG. 1, a multilayered structure was formed that included a foam center layer sandwiched between two skin layers. The foam center layer was about 10 mils thick and was formed using a blend that included 50 wt % LLDPE and 50 wt % LDPE. The foamed sheet with sandwich (three layers) structure was made by continuous cast sheet extrusion with a chemical blowing agent. The blowing agent used was ECOCELL-H™ produced by Polyfil Corporation™, used in 2.5 wt %. The skin layers included 100 wt % LLDPE, and were about 5 mils thick. The 3-layered structure was reinforced via laminating with a 1300 denier polyester scrim using a hot 3-layered structure extruded using a second extrusion, which was identical to the 3-layered structure formed during the first extrusion. The resulting material had two 3-layered structures sandwiching a layer of the scrim, as illustrated in FIG. 1. The resulting structure had a density of 0.7-0.9 g/cm³, and a thickness of 30-80 mils.

The reinforced multilayered structure had a tensile strength of about 170 ldf/in, a tear resistance of about 160 lbf, and a puncture resistance of about 120 lbf.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### Additional Embodiments

The present invention provides for the following exemplary embodiments, the numbering of which is not to be construed as designating levels of importance:

Embodiment 1 provides a foam, comprising: a solid composition comprising polyethylene; and a gaseous composition comprising a blowing agent.

Embodiment 2 provides the foam of Embodiment 1, wherein the solid composition comprises LDPE, LLDPE, MDPE, HDPE, VLDPE, ULDPE, polyolefin plastomer, or any combination thereof.

Embodiment 3 provides the foam of any one of Embodiments 1-2, wherein the solid composition comprises a blend of LDPE and a linear polyolefin.

Embodiment 4 provides the foam of Embodiment 3, wherein the linear polyolefin comprises at least one of HDPE, MDPE, LLDPE, VLDPE, ULDPE, and polyolefin plastomer.

Embodiment 5 provides the foam of any one of Embodiments 3-4, wherein the linear polyolefin comprises LLDPE.

Embodiment 6 provides the foam of any one of Embodiments 3-5, wherein the solid composition comprises about 0.1 wt % to about 99.9 wt % of the linear polyolefin.

Embodiment 7 provides the foam of any one of Embodiments 3-6, wherein the solid composition comprises about 20-80 wt % of the linear polyolefin.

Embodiment 8 provides the foam of any one of Embodiments 1-7, wherein the solid composition comprises about 0.1 wt % to about 99.9 wt % LLDPE.

Embodiment 9 provides the foam of any one of Embodiments 1-8, wherein the solid composition comprises about 20-80 wt % LLDPE.

Embodiment 10 provides the foam of any one of Embodiments 1-9, wherein the solid composition comprises about 0.1 wt % to about 99.9 wt % LDPE.

Embodiment 11 provides the foam of any one of Embodiments 1-10, wherein the solid composition comprises about 20 wt % to about 80 wt % LDPE.

Embodiment 12 provides the foam of any one of Embodiments 1-11, wherein the solid composition further comprises a UV stabilizer, a UV absorber, an antioxidant, a pigment material, a filler, or a polyolefin.

Embodiment 13 provides the foam of any one of Embodiments 1-12, wherein the solid composition further comprises at least one of a nucleating agent, a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, carbon black, a polyolefin, a linear polyolefin, a linear polyolefin copolymer, UHMWPE, HDPE, PEX, XLPE, MDPE, VLDPE, ULDPE, a polyolefin plastomer, a chemical blowing agent, a chemical blowing agent residue, and a flow control additive.

Embodiment 14 provides the foam of any one of Embodiments 1-13, wherein the foam has a tensile strength of about 0.001 lbf/in to about 1000 lbf/in.

Embodiment 15 provides the foam of any one of Embodiments 1-14, wherein the blowing agent comprises at least one of a branched or linear C₁₋₅ alkane, ethane, propane, butane, n-butane, isobutane, pentane, isopentane, cyclopentane, halo(C₁₋₅)alkanes, chlorofluorocarbon, CFC-11, CFC-12, hydroflurochlorocarbons, HCFC-22, HCFC-122, HCFC-124, HFC-152a, HFC-143a, HFC-134a, HCFC-141b, HCFC-142b, air, carbon dioxide, oxygen, hydrogen, water, and nitrogen.

Embodiment 16 provides the foam of any one of Embodiments 1-15, wherein the blowing agent is produced during manufacture of the foam by a chemical blowing agent comprising at least one of azodicarbonamide, an azodicarbonamide derivative, sodium bicarbonate, an aliphatic sulfonyl semicarbazide, p-toluenesulfonylhydrazide, p-toluenesulfonylsemicarbazide, 4,4-oxybisbenzenesulfonylhydrazide, 5-phenyltetrazole, and citric acid.

Embodiment 17 provides the foam of any one of Embodiments 1-16, wherein the foam comprises an extruded sheet.

Embodiment 18 provides the foam of any one of Embodiments 1-17, wherein the foam has a thickness of about 1 mils to about 3000 mils.

Embodiment 19 provides the foam of any one of Embodiments 1-18, wherein the foam has a thickness of about 5 mils to about 500 mils.

Embodiment 20 provides the foam of any one of Embodiments 1-19, wherein the density of the foam is about 0.5 to about 1.0 g/cm³.

Embodiment 21 provides the foam of any one of Embodiments 1-20, wherein the density of the foam is about 0.5 g/cm³ to about 0.9 g/cm³.

Embodiment 22 provides a multilayered structure, comprising: at least one first layer comprising polyethylene; and at least one second layer comprising the foam of any one of Embodiments 1-21.

Embodiment 23 provides the multilayered structure of Embodiment 22, wherein the at least one first layer comprises LLDPE.

Embodiment 24 provides the multilayered structure of any one of Embodiments 22-23, wherein the at least one first layer comprises about 50 wt % to about 100 wt % LLDPE.

Embodiment 25 provides the multilayered structure of any one of Embodiments 22-24, wherein the at least one first layer comprises about 95 wt % to about 100 wt % LLDPE.

Embodiment 26 provides the multilayered structure of any one of Embodiments 22-25, wherein the at least one first layer comprises about 0 wt % to about 50 wt % LDPE.

Embodiment 27 provides the multilayered structure of any one of Embodiments 22-26, wherein the at least one first layer comprises about 0 wt % to about 5 wt % LDPE.

Embodiment 28 provides the multilayered structure of any one of Embodiments 22-27, wherein the at least one first layer further comprises at least one of a surfactant, an emulsifier, a dispersant, a polymeric stabilizer, a crosslinking agent, a polymer, a combination of polymers, a catalyst, a rheology modifier, a density modifier, an aziridine stabilizer, a cure modifier, a free radical initiator, a diluent, an acid acceptor, an antioxidant, a heat stabilizer, a flame retardant, a scavenging agent, a foam stabilizer, a solvent, a plasticizer, filler, an inorganic particle, a pigment, a dye, a dessicant, an adhesion promoter, a heat stabilizer, a UV stabilizer, a UV absorber, carbon black, a polyolefin, UHMWPE, HDPE, PEX, XLPE, MDPE, VLDPE, a chemical blowing agent, a chemical blowing agent residue, and a flow control additive.

Embodiment 29 provides the multilayered structure of any one of Embodiments 22-28, wherein the at least one first layer has a thickness of about 1-40 mils.

Embodiment 30 provides the multilayered structure of any one of Embodiments 22-29, wherein the at least one first layer has a thickness of about 2-20 mils.

Embodiment 31 provides the multilayered structure of any one of Embodiments 22-30, wherein the at least one first layer is in contact with the at least one second layer.

Embodiment 32 provides a multilayered structure, comprising: a) at least one first layer comprising polyethylene; and b) at least one second layer comprising the foam of any one of Embodiments 1-21; wherein layer a) is in contact with layer b).

Embodiment 33 provides a multilayered structure, comprising: a) at least one first layer comprising polyethylene; b) at least one second layer comprising the foam of any one of Embodiments 1-21; and c) at least one first layer comprising polyethylene; wherein layer a) is in contact with layer b), and layer b) is in contact with layer c).

Embodiment 34 provides the multilayered structure of any one of Embodiments 22-33, further comprising: at least one reinforcing layer comprising scrim and optionally comprising polyethylene comprising at least one of HDPE, MDPE, LLDPE, VLDPE, ULDPE, and polyolefin plastomer, wherein the reinforcing layer has a thickness of about 1 to about 40 mils or about 1 to about 20 mils.

Embodiment 35 provides the multilayered structure of Embodiment 33, wherein the scrim comprises at least one of glass, polyester, polyethylene, polypropylene, nylon, carbon, Aramid and steel.

Embodiment 36 provides the multilayered structure of any one of Embodiments 34-35, wherein the scrim comprises yarn of about 300 denier to about 3000 denier.

Embodiment 37 provides the multilayered structure of Embodiment 34, wherein the scrim is about 600 denier to about 1300 denier.

Embodiment 38 provides the multilayered structure of any one of Embodiments 22-37, wherein the multilayered structure is formed using continuous cast sheet extrusion.

Embodiment 39 provides the multilayered structure of any one of Embodiments 34-37, wherein the at least one reinforcing layer is in contact with the at least one first layer.

Embodiment 40 provides a multilayered structure, comprising: b) at least one layer comprising the foam of any one of Embodiments 1-21; c) at least one layer comprising polyethylene; and d) at least one reinforcing layer comprising scrim and optionally comprising polyethylene; wherein layer b) is in contact with layer c), and layer c) is in contact with layer d).

Embodiment 41 provides a multilayered structure, comprising: a) at least one first layer comprising polyethylene; b) at least one second layer comprising the foam of any one of Embodiments 1-21; c) at least one first layer comprising polyethylene; d) at least one reinforcing layer comprising scrim and optionally comprising polyethylene; e) at least one first layer comprising polyethylene; f) at least one second layer comprising the foam of any one of Embodiments 1-21; and g) at least one first layer comprising polyethylene; wherein layer a) is in contact with layer b), layer b) is in contact with layer c), layer c) is in contact with layer d), layer d) is in contact with layer e), layer e) is in contact with layer f), and layer f) is in contact with layer g).

Embodiment 42 provides the multilayered structure of any one of Embodiments 22-41, wherein the total thickness of the multilayered structure is about 1 mils to about 3000 mils.

Embodiment 43 provides the multilayered structure of any one of Embodiments 22-42, wherein the total thickness of the multilayered structure is about 30 mils to about 80 mils.

Embodiment 44 provides the multilayered structure of any one of Embodiments 22-43, wherein the overall density of the multilayered structure is about 0.4 to about 1.1 g/cm³.

Embodiment 45 provides the multilayered structure of any one of Embodiments 22-44, wherein the overall density of the multilayered structure is about 0.7 g/cm³ to about 0.9 g/cm³.

Embodiment 46 provides the multilayered structure of any one of Embodiments 22-45, wherein the multilayered structure has a tensile strength of about 100 lbf/in to about 300 lbf/in.

Embodiment 47 provides the multi-layered structure of any one of Embodiments 22-46, wherein the structure comprises at least one of packaging, a construction film or liner, an agricultural film or liner, and a geomembrane.

Embodiment 48 provides a multilayered structure, comprising: a) at least one first layer comprising about 95 wt % to about 100 wt % LLDPE; b) at least one second layer comprising a foam comprising a solid composition comprising a blend of LDPE and a linear polyolefin, the composition comprising about 20 wt % to about 80 wt % of the LDPE and about 20 wt % to about 80 wt % of the linear polyolefin; and a gaseous composition comprising a blowing agent; c) at least one first layer comprising about 95 wt % to about 100 wt % LLDPE; d) at least one reinforcing layer comprising scrim and optionally comprising polyethylene; e) at least one first layer comprising about 95 wt % to about 100 wt % LLDPE; f) at least one second layer comprising a foam comprising a solid composition comprising a blend of LDPE and a linear polyolefin, the composition comprising about 20 wt % to about 80 wt % of the LDPE and about 20 wt % to about 80 wt % of the linear polyolefin; and a gaseous composition comprising a blowing agent; and g) at least one first layer comprising about 95 wt % to about 100 wt % LLDPE; wherein layer a) is in contact with layer b), layer b) is in contact with layer c), layer c) is in contact with layer d), layer d) is in contact with layer e), layer e) is in contact with layer f), and layer f) is in contact with layer g), the multilayered structure has a total thickness of about 30 mils to about 80 mils, and the multilayered structure has an overall density of about 0.7 g/cm³ to about 0.9 g/cm³.

Embodiment 49 provides the multilayered structure of Embodiment 46, wherein the linear polyolefin comprises LLDPE.

Embodiment 50 provides the multilayered structure of any one of Embodiments 47-49, wherein the multilayered structure comprises a geomembrane.

Embodiment 51 provides a method comprising using the multilayered structure of any one of Embodiments 22-48.

Embodiment 52 provides a method of making the multilayered structure of any one of Embodiments 22-48.

Embodiment 53 provides a method of making a multilayered structure, comprising: extruding the foam layer of any one of claims 1-21; extruding a first layer comprising polyethylene; and assembling a multilayered structure comprising c) at least one of the first layer comprising polyethylene, and b) at least one of a second layer comprising the foam layer; wherein layer b) is in contact with layer c).

Embodiment 54 provides the multilayered structure of Embodiment 53, wherein the linear polyolefin comprises LLDPE.

Embodiment 55 provides the method of any one of Embodiments 53-54, further comprising: adding to the multilayered structure layer d), at least one reinforcing layer comprising scrim and optionally comprising polyethylene; wherein layer d) is in contact with layer c).

Embodiment 56 provides the method of any one of Embodiments 53-54, wherein the multilayered structure comprises a) at least one first layer comprising polyethylene; b) at least one second layer comprising the foam of any one of Embodiments 1-21; c) at least one first layer comprising polyethylene; d) at least one reinforcing layer comprising scrim and optionally comprising polyethylene; e) at least one first layer comprising polyethylene; f) at least one second layer comprising the foam of any one of Embodiments 1-21; and g) at least one first layer comprising polyethylene; wherein layer a) is in contact with layer b), layer b) is in contact with layer c), layer c) is in contact with layer d), layer d) is in contact with layer e), layer e) is in contact with layer f), and layer f) is in contact with layer g).

Embodiment 57 provides the method of Embodiment 56, wherein the multilayered structure has a total thickness of about 30 mils to about 80 mils and an overall density of about 0.7 g/cm³ to about 0.8 g/cm³.

Embodiment 58 provides a method of making a geomembrane, comprising the method of any one of Embodiments 53-57.

Embodiment 59 provides a multilayered structure, comprising: a) at least one first layer comprising polyethylene; b) at least one second layer comprising a foam comprising a solid composition comprising LDPE, LLDPE, MDPE, HDPE, VLDPE, ULDPE, polyolefin plastomer, or any combination thereof, and a gaseous composition including a blowing agent; c) at least one first layer comprising polyethylene; and d) at least one reinforcing layer comprising scrim and optionally comprising polyethylene; wherein layer a) is in contact with layer b), layer b) is in contact with layer c), and layer d) is in contact with the at least one first layer a) or c).

Embodiment 60 provides the multilayered structure of claim 59, further comprising e) at least one first layer comprising polyethylene; f) at least one second layer comprising a foam comprising a solid composition comprising LDPE, LLDPE, MDPE, HDPE, VLDPE, ULDPE, polyolefin plastomer, or any combination thereof, and a gaseous composition including a blowing agent; and g) at least one first layer comprising polyethylene; wherein layer a) is in contact with layer b), layer b) is in contact with layer c), layer c) is in contact with layer d), layer d) is in contact with layer e), layer e) is in contact with layer f), and layer f) is in contact with layer g).

Embodiment 61 provides the foam, multilayered structure, or method of any one or any combination of Embodiments 1-60 optionally configured such that all elements or options recited are available to use or select from.

What is claimed is:

1. A foam, comprising:
a solid composition comprising a blend of LDPE and a linear polyolefin; and
a gaseous composition comprising a blowing agent.

2. The foam of claim 1, wherein the linear polyolefin comprises at least one of HDPE, MDPE, LLDPE, VLDPE, ULDPE, and polyolefin plastomer.

3. The foam of claim 1, wherein the linear polyolefin comprises LLDPE.

4. The foam of claim 1, wherein the solid composition comprises about 0.1 wt % to about 99.9 wt % linear polyolefin.

5. The foam of claim 1, wherein the solid composition further comprises a UV stabilizer, a UV absorber, an antioxidant, a pigment material, a nucleating agent, a filler, or a polyolefin.

6. The foam of claim 1, wherein the foam has a thickness of about 1 mils to about 3000 mils.

7. The foam of claim 1, wherein the density of the foam is about 0.5 to about 1.0 g/cm³.

8. A multilayered structure, comprising:
at least one first layer comprising polyethylene; and
at least one second layer comprising the foam of claim 1.

9. The multi-layered structure of claim 8, wherein the structure comprises at least one of packaging, a construction film or liner, an agricultural film or liner, and a geomembrane.

10. The multilayered structure of claim 8, wherein the at least one first layer comprises LLDPE.

11. The multilayered structure of claim 8, wherein the at least one first layer has a thickness of about 1-40 mils.

12. A multilayered structure, comprising:
a) at least one first layer comprising polyethylene;
b) at least one second layer comprising the foam of claim 1; and
c) at least one first layer comprising polyethylene;
wherein layer a) is in contact with layer b), and layer b) is in contact with layer c).

13. The multilayered structure of claim 8, further comprising:
at least one reinforcing layer in contact with the at least one first layer.

14. The multilayered structure of claim 13, wherein the reinforcing layer comprises scrim and optionally comprises polyethylene.

15. A multilayered structure, comprising:
b) at least one second layer comprising the foam of claim 1;
c) at least one first layer comprising polyethylene; and
d) at least one reinforcing layer comprising scrim and optionally comprising polyethylene;
wherein layer b) is in contact with layer c), and layer c) is in contact with layer d).

16. A multilayered structure, comprising:
a) at least one first layer comprising polyethylene;
b) at least one second layer comprising the foam of claim 1;
c) at least one first layer comprising polyethylene;
d) at least one reinforcing layer comprising scrim and optionally comprising polyethylene;
e) at least one first layer comprising polyethylene;
f) at least one second layer comprising the foam of claim 1; and
g) at least one first layer comprising polyethylene;
wherein layer a) is in contact with layer b), layer b) is in contact with layer c), layer c) is in contact with layer d), layer d) is in contact with layer e), layer e) is in contact with layer f), and layer f) is in contact with layer g).

17. The multilayered structure of claim 16, wherein
the least one first layer a) comprises about 95 wt % to about 100 wt % LLDPE;
the at least one second layer b) comprises a foam comprising
a solid composition comprising a blend of LDPE and a linear polyolefin, the composition comprising about 20 wt % to about 80 wt % of the LDPE and about 20 wt % to about 80 wt % of the linear polyolefin; and
a gaseous composition comprising a blowing agent;
the at least one first layer c) comprises about 95 wt % to about 100 wt % LLDPE;
the at least one first layer e) comprises about 95 wt % to about 100 wt % LLDPE;
the at least one second layer f) comprises a foam comprising
a solid composition comprising a blend of LDPE and a linear polyolefin, the composition comprising about 20 wt % to about 80 wt % of the LDPE and about 20 wt % to about 80 wt % of the linear polyolefin; and
a gaseous composition comprising a blowing agent; and
the at least one first layer g) comprises about 95 wt % to about 100 wt % LLDPE;
wherein layer a) is in contact with layer b), layer b) is in contact with layer c), layer c) is in contact with layer d), layer d) is in contact with layer e), layer e) is in contact with layer f), and layer f) is in contact with layer g),
the multilayered structure has a total thickness of about 30 mils to about 80 mils, and
the multilayered structure has an overall density of about 0.7 g/cm³ to about 0.9 g/cm³.

18. A multilayered structure, comprising:
a) at least one first layer comprising polyethylene;
b) at least one second layer comprising a foam comprising
a solid composition comprising LDPE, LLDPE, MDPE, HDPE, VLDPE, ULDPE, polyolefin plastomer, or any combination thereof, and
a gaseous composition including a blowing agent;
c) at least one first layer comprising polyethylene; and
d) at least one reinforcing layer comprising scrim and optionally comprising polyethylene;
wherein layer a) is in contact with layer b), layer b) is in contact with layer c), and layer d) is in contact with the at least one first layer a) or c).

19. The multilayered structure of claim 18, further comprising
e) at least one first layer comprising polyethylene;
f) at least one second layer comprising a foam comprising
a solid composition comprising LDPE, LLDPE, MDPE, HDPE, VLDPE, ULDPE, polyolefin plastomer, or any combination thereof, and
a gaseous composition including a blowing agent; and
g) at least one first layer comprising polyethylene;
wherein layer a) is in contact with layer b), layer b) is in contact with layer c), layer c) is in contact with layer d), layer d) is in contact with layer e), layer e) is in contact with layer f), and layer f) is in contact with layer g).

20. A method of making a multilayered structure, comprising:
extruding a foam layer comprising
a solid composition comprising a blend of LDPE and a linear polyolefin, and
a gaseous composition comprising a blowing agent;
extruding a first layer comprising polyethylene; and
assembling a multilayered structure comprising
b) at least one of the first layer comprising polyethylene, and
c) at least one of a second layer comprising the foam layer;
wherein layer b) is in contact with layer c).
